(19) United States
(12) Patent Application Publication
(10) Pub. No.: US 2026/0350121 A1
(43) Pub. Date: Nov. 5, 2026

(54) NEURAL NETWORK SYSTEM FOR PROVIDING METADATA WITH OUTPUT

(71) Applicant: DEEPX CO., LTD., Seongnam-si (KR)

(72) Inventor: Lok Won KIM, Seongnam-si (KR)

(21) Appl. No.: 19/629,085

(22) Filed: Mar. 26, 2026

(30) Foreign Application Priority Data
Apr. 22, 2025 (KR) 10-2025-0052392

(51) Int. Cl. G06F 21/16; G06T 1/00; G06T 11/60

(52) U.S. Cl. CPC G06F 21/16; G06T 1/0021; G06T 11/60; G06T 2200/24

(57) ABSTRACT

Computer systems, apparatus, and methods are described. According to one embodiment, a system comprises an interface to obtain input data from a user, one or more external memories to store a result of compiling an artificial intelligence model based on an artificial neural network, and a neural processing unit (NPU) to generate output data by performing an inference operation on the input data using the compilation result. The NPU comprises a controller to control an operation of the NPU and schedule the inference operation, a processing core to perform the inference operation, and at least one internal memory to store a parameter of the artificial neural network required for the inference operation. Metadata enabling recognition of an origin of the output data is added to the output data. The metadata includes hardware identification information of the NPU or information on the artificial intelligence model. The metadata is stored in the internal memory.

### CROSS-REFERENCE TO RELATED APPLICATIONS

This application claims priority to Korean Patent Application No. 10-2025-0052392 filed on Apr. 22, 2025, the disclosure of which is incorporated herein by reference.

### BACKGROUND OF THE DISCLOSURE

### Technical Field

The present disclosure relates to a system performing artificial intelligence operations, and more particularly, to a system, an apparatus, and a method for outputting metadata together with an output of a neural processing unit (NPU).

### Background Art

With the recent rapid development of content creation technologies utilizing artificial intelligence (AI), various services that innovatively improve user experience have emerged. For example, images, pictures, and videos may be generated based on generative artificial intelligence (AI) technology, and the artificial intelligence technology is being utilized in various fields including news articles, videos, and tutorials. In order to generate such content utilizing the artificial intelligence technology, a user must input a prompt. The prompt may include a text prompt, an image prompt, a reference text, a complex prompt, and the like. The text prompt refers to a method of inputting instructions or contexts to be followed as text to directly generate a result in an artificial intelligence engine. The image prompt refers to a method of inputting an underlying image to generate or transform a new image. The reference text refers to a method enabling the artificial intelligence engine to learn a specific style or structure to generate a result similar to what has been learned. The complex prompt is a method in which an artificial intelligence model generates a result by combining text and images.

The artificial intelligence engine may be used to automatically generate or edit a video by receiving a keyword or a reference video from the user. For example, when a keyword or prompt for a specific topic is provided, the artificial intelligence engine may generate a user-defined video by combining suitable stock videos, images, and animations. In addition, a new video having similar characteristics may be automatically produced by analyzing a style, a color, a movement, and the like of a reference video uploaded by the user. This is being utilized in various fields including public relations, education, and marketing.

The artificial intelligence-based content generation technology has greatly improved user convenience and productivity, but has problems related to copyrights and intellectual property rights, and laws and systems for them are currently being rearranged in various countries around the world. The problems may broadly include to whom the copyright of the content generated by the artificial intelligence technology belongs and ethical and social controversies of content generated as a deepfake. The deepfake is a technology that realistically manipulates or synthesizes a person's face, voice, or specific image by utilizing the artificial intelligence technology. Mainly, fake content is generated based on an original video or audio using a deep learning model called generative adversarial networks (GAN). While this technology has a positive function of being utilized as an innovative tool for content creation, there are also many adverse functions such as malicious utilization or utilization for fake news by manipulating a specific person's face or voice. In particular, it becomes increasingly difficult to determine the authenticity of video and audio, which may lead to a decline in trust in digital content overall.

Technologies such as GPTZero, OpenAI AI Classifier, Turnitin AI Detection, Sensity AI, and Deepware Scanner exist for analyzing text, images, and videos to determine whether specific content was generated by artificial intelligence. However, these technologies have limitations as they determine whether content is generated by artificial intelligence by analyzing patterns or features of the content. Alternatively, an origin indication may be added as post-processing to an image in a server providing a generative artificial intelligence service, but there is a risk of falsification or deletion.

Meanwhile, with the recent development of the artificial intelligence technology, the use of a dedicated hardware accelerator such as the neural processing unit (NPU) is rapidly increasing. The neural processing unit (NPU) has a structure capable of efficiently performing large-scale neural network operations, and plays a key role in various artificial intelligence (AI) application fields including image recognition, voice recognition, and natural language processing. A graphic processing unit (GPU) is currently widely used for artificial intelligence operations, but its role is being gradually replaced by the neural processing unit (NPU) that is designed to exclusively perform the artificial intelligence operations and is optimized for the artificial intelligence operations.

### SUMMARY OF THE DISCLOSURE

An object of the present disclosure is to provide a system, an apparatus, and a method capable of providing metadata together with an output result of a neural processing unit (NPU).

Technical problems to be achieved by the present disclosure are not limited to the technical problems described above, and other technical problems may be inferred from the following embodiments.

In order to achieve the above object, according to an aspect of the present disclosure, a system is provided. The system includes an interface to obtain input data from a user, one or more external memories to store a result of compiling an artificial intelligence model based on an artificial neural network, and a neural processing unit (NPU) generating output data by performing an inference operation on the input data using the compilation result. The neural processing unit (NPU) includes a controller to control an operation of the neural processing unit (NPU) and schedule the inference operation, a processing core to perform the inference operation, and at least one internal memory to store parameters of the artificial neural network required for the inference operation. Metadata enabling recognition of an origin of the output data is added to the output data. The metadata includes hardware identification information of the neural processing unit (NPU) or information on the artificial intelligence model. The metadata is stored in the internal memory.

According to an aspect of the present disclosure, a system is provided. The system includes an interface to receive a prompt input by a user, one or more external memories to store a result of compiling an artificial intelligence model based on a generative artificial neural network, and a neural processing unit (NPU) to generate a technical tutorial video by performing an inference operation on the prompt based on the compilation result. The neural processing unit (NPU) includes a script generator to generate a script suitable for a length of the technical tutorial video desired by the user based on the prompt, a reference video obtainer to obtain at least one reference video clip based on the prompt, an image generator to obtain technical tutorial video data by mapping the script and the reference video clip over time, and an internal memory to store hardware identification information of the neural processing unit (NPU). The interface outputs the technical tutorial video data to the outside by adding the hardware identification information to the technical tutorial video data.

According to an aspect of the present disclosure, a neural processing unit is provided. The neural processing unit includes a static random-access memory (SRAM) to load and store at least a portion of a compilation result of an artificial intelligence model based on an artificial neural network, a controller to control an operation of the neural processing unit and schedule an inference operation, an input/output (I/O) interface to receive input data, a processing core to generate output data by performing the inference operation using the compilation result, and a read-only memory (ROM) to store hardware identification information of the neural processing unit, and the controller adds the hardware identification information to the output data and the input/output (I/O) interface includes an output interface to transmit to the outside. The hardware identification information includes manufacturer information of the neural processing unit (NPU), a model name of the neural processing unit (NPU), or a serial number of the neural processing unit (NPU).

According to an aspect of the present disclosure, metadata is provided to a user in association with an output of a neural processing unit (NPU).

The metadata is origin information and includes manufacturer information, a product identifier, a type of a model, and/or a learning history. Based on this information, which is difficult to forge, falsify, or delete, the user verifies an output result of the neural processing unit (NPU), manages a history of the output result, and recognizes an origin of the output result.

### BRIEF DESCRIPTION OF THE DRAWINGS

FIG. 1 is a schematic conceptual diagram illustrating an exemplary neural network model.

FIG. 2A is a diagram for describing a basic structure of a convolutional neural network (CNN).

FIG. 2B is a comprehensive diagram illustrating operations of the convolutional neural network (CNN) for easy understanding.

FIG. 3 is a block diagram of a neural processing unit (NPU) according to an example of the present disclosure.

FIG. 4A is a schematic conceptual diagram illustrating one processing element applicable to an example of the present disclosure.

FIG. 4B is a schematic conceptual diagram illustrating a special function unit (SFU) applicable to an example of the present disclosure.

FIG. 5 is an exemplary diagram illustrating a modified example of the neural processing unit 100 illustrated in FIG. 3.

FIG. 6A is a block diagram illustrating a computer system according to an example, and FIG. 6B is a block diagram illustrating a computer system according to another example.

FIG. 7 illustrates an example in which text-type metadata is output together with an inference result of a neural processing unit (NPU).

FIG. 8 illustrates an example in which image-type metadata is synthesized with an input image.

FIG. 9A illustrates an example in which image-type metadata is synthesized with an output image.

FIG. 9B illustrates an example of an output image.

FIG. 10 is a block diagram illustrating a computer system according to another example.

FIG. 11 is a block diagram illustrating a neural processing unit (NPU) according to an embodiment.

### DETAILED DESCRIPTION OF THE PRESENT DISCLOSURE

Specific structural or step-by-step descriptions of examples of the present disclosure are provided merely for describing examples according to the concept of the present disclosure. Therefore, the examples according to the concept of the present disclosure may be implemented in various forms. The examples according to the concept of the present disclosure may be implemented in various forms. The present disclosure should not be construed as being limited to the examples of the present disclosure.

Various modifications may be made to the examples according to the concept of the present disclosure, and the examples may have various forms. Accordingly, specific examples will be illustrated in the drawings and the present disclosure or application will be described in detail. However, this is not intended to limit the examples according to the concept of the present disclosure to a specific disclosed form. The examples according to the concept of the present disclosure should be understood to include all modifications, equivalents, and substitutes included in the spirit and technical scope of the present disclosure.

Terms such as first and/or second may be used to describe various components, but the components should not be limited by the terms. The terms may be used only for the purpose of distinguishing one component from another component. Without departing from the scope of rights according to the concept of the present disclosure, a first component may be referred to as a second component, and similarly, a second component may also be referred to as a first component.

When a component is referred to as being “connected” or “coupled” to another component, it may be directly connected or coupled to the other component. However, it should be understood that other components may exist between the plurality of components. On the other hand, when a component is referred to as being “directly connected” or “directly coupled” to another component, it should be understood that there are no other components in between. Other expressions describing relationships between components, that is, “between” and “directly between” or “adjacent to” and “directly adjacent to,” should be interpreted similarly.

The terminology used in the present disclosure is only used to describe specific examples, and is not intended to limit the present disclosure. A singular expression includes a plural expression unless the context clearly indicates otherwise. In the present disclosure, terms such as “include” or “have” are intended to designate the existence of a stated feature, number, step, operation, component, part, or combination thereof. Therefore, it should be understood that the possibility of the existence or addition of one or more other features, numbers, steps, operations, components, parts, or combinations thereof is not excluded in advance.

Unless defined otherwise, all terms used herein, including technical or scientific terms, have the same meaning as commonly understood by one of ordinary skill in the art to which the present disclosure belongs. Terms such as those defined in commonly used dictionaries should be interpreted as having meanings consistent with the meanings in the context of the related art. Terms such as those defined in commonly used dictionaries are not interpreted in an ideal or excessively formal meaning unless clearly defined in the present disclosure.

In describing the examples, descriptions of technical contents that are well known in the technical field to which the present disclosure belongs and are not directly related to the present disclosure are omitted. This is to more clearly deliver the gist of the present disclosure without obscuring the gist by omitting unnecessary descriptions.

### DEFINITION OF TERMS

Hereinafter, to help understanding of the disclosures presented in the present disclosure, terms used in the present disclosure will be briefly summarized.

Generative artificial intelligence (AI): Means an artificial intelligence technology capable of automatically generating new content in various forms such as text, images, audio, and codes based on patterns learned from large-scale data. Generative artificial intelligence may generally be implemented including a deep learning-based generative model, for example, a transformer architecture or a generative adversarial network (GAN), and the like.

NPU: An abbreviation for a neural processing unit, and may mean a processor specialized for operations of a neural network model separately from a central processing unit (CPU).

NN: An abbreviation for a neural network, and may mean a network in which nodes are connected in a layer structure by imitating a connection of neurons in a human brain through a synapse in order to imitate human intelligence.

DNN: An abbreviation for a deep neural network, and may mean increasing the number of hidden layers of an artificial neural network in order to implement higher artificial intelligence.

CNN: An abbreviation for a convolutional neural network, and is a neural network having a function similar to processing an image in a visual cortex of a human brain. The convolutional neural network (CNN) is known to be suitable for image processing, and is known to be easy to extract features of input data and grasp patterns of the features.

Transformer is an artificial intelligence model implemented based on an attention mechanism, and may be used in a language model (a large language model (LLM) and a small LLM). The language model includes BERT (Bidirectional Encoder Representations from Transformers), GPT (Generative Pre-trained Transformer), RoBERTa (Robustly Optimized BERT Pretraining Approach), ALBERT (A Lite BERT), ELECTRA (Efficiently Learning an Encoder that Classifies Token Replacements Accurately), Transformer-XL (Transformer with Extra Long Context), XLNet (a model combining advantages of GPT and BERT), BART (Bidirectional and Auto-Regressive Transformers), CTRL (Conditional Transformer Language), T5 (Text-to-Text Transfer Transformer), LaMDA (Language Model for Dialogue Applications), Gopher (an LLM of DeepMind), InstructGPT (a GPT-3 based fine-tuned model), PanGu (a Chinese model of Huawei), PaLM (Pathways Language Model), OPT 175B (Open Pretrained Transformer 175B), BLOOM (BigScience Large Open-science Open-access Multilingual Model), HyperCLOVA (a Korean hyper-scale model of Naver), and the like, and may also include new language models to appear in the future.

The transformer may be utilized not only in natural language processing (NLP) but also in image processing (computer vision), and representative transformer-based image models include a vision transformer (ViT), a sliding window-based transformer for vision (Swin Transformer), and the like. A generative model such as Stable Diffusion utilizes a transformer structure for a text encoder, but uses a CNN-based structure for image generation itself. Hereinafter, ‘inference’ may include generative inference generating a new creation as well as classification.

Dedicated memory: As a dedicated memory provided for data processed by a neural processing unit (NPU), the dedicated memory may be configured to store parameters of a neural network model and provide data necessary for processing the neural network model to the neural processing unit (NPU) in real time. The dedicated memory is packaged together with the neural processing unit (NPU), and may improve communication quality (e.g., a signal-to-noise ratio) by minimizing a length of a data transmission path.

Hereinafter, the present disclosure will be described in detail by describing preferred examples of the present disclosure with reference to the accompanying drawings. Hereinafter, examples of the present disclosure will be described in detail with reference to the accompanying drawings.

### <Artificial Intelligence>

Humans possess intelligence capable of performing recognition, classification, inference, prediction, and control/decision making. Artificial intelligence (AI) means artificially imitating human intelligence.

A human brain includes numerous nerve cells called neurons. Each neuron is connected to hundreds to thousands of other neurons through a connection region called a synapse. In order to imitate human intelligence, modeling an operating principle of a biological neuron and a connection relationship between neurons is called a neural network model. That is, an artificial neural network is a system in which nodes imitating neurons are connected in a layer structure.

Such a neural network model is classified into a ‘single-layer neural network’ and a ‘multi-layer neural network’ according to the number of layers. A general multi-layer neural network includes an input layer, a hidden layer, and an output layer. (1) The input layer is a layer that receives external data, and the number of neurons in the input layer is equal to the number of input variables. (2) The hidden layer is located between the input layer and the output layer, receives a signal from the input layer, extracts features, and transfers the features to the output layer. (3) The output layer receives a signal from the hidden layer and outputs the signal to the outside. An input signal between neurons is multiplied by each connection strength having a value between 0 and 1, and then summed. When this sum is greater than a threshold of a neuron, the neuron is activated and implemented as an output value through an activation function.

Meanwhile, in order to implement higher artificial intelligence, increasing the number of hidden layers of an artificial neural network is referred to as a deep neural network (DNN).

The deep neural network (DNN) is being developed into various structures. For example, a convolutional neural network (CNN), which is an example of the deep neural network (DNN), is known to be easy to extract features of an input value (a video or an image) and grasp a pattern of the extracted output value. The convolutional neural network (CNN) may be configured in a form in which a convolution operation, an activation function operation, a pooling operation, and the like are processed in a specific order.

For example, in each layer of the deep neural network (DNN), a parameter (i.e., an input value, an output value, a weight, a kernel, etc.) may be a matrix including a plurality of channels. The parameter may be processed in a neural processing unit (NPU) by convolution or matrix multiplication. An output value processed with an operation is generated in each layer.

For example, a transformer model is a deep neural network (DNN) based on an attention technology. The transformer utilizes a number of matrix multiplication operations. The transformer may obtain an attention score (Q, K, V) that is an output value by using an input value and parameters such as a query (Q), a key (K), and a value (V). The transformer may process various inference operations based on the output value (that is, the attention score (Q, K, V)). The transformer tends to show better inference performance than the convolutional neural network (CNN).

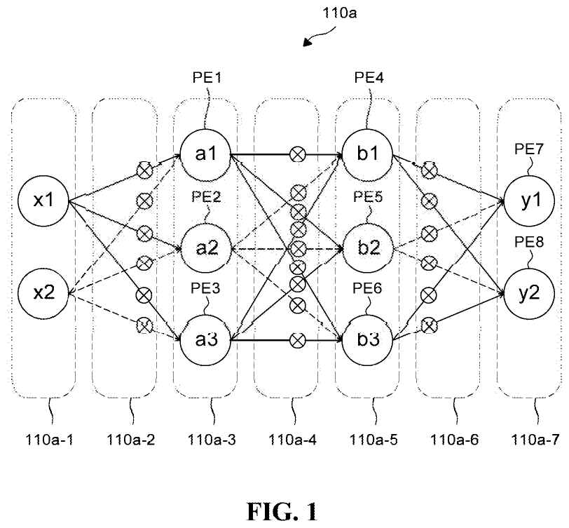

FIG. 1 is a schematic conceptual diagram illustrating an exemplary neural network model.

Hereinafter, an operation of an exemplary neural network model 110a that may be operated in a neural processing unit 100 will be described.

The exemplary neural network model 110a of FIG. 1 may be an artificial neural network trained to perform various inference functions including object recognition, voice recognition, natural language processing, token generation, image generation, and the like. The neural network model 110a may be a deep neural network (DNN). However, the neural network model 110a according to the examples of the present disclosure is not limited to the deep neural network.

For example, the neural network model 110a may be implemented as models including Chat-GPT, LLaMA, Stable Diffusion, a large language model (LLM), generative adversarial networks (GAN), Florence, DaViT, MobileViT, Swin-Transformer, Transformer, YOLO, CNN, PIDNet, BiseNet, RCNN, VGG, VGG16, DenseNet, SegNet, DeconvNet, DeepLAB V3+, U-net, SqueezeNet, Alexnet, ResNet18, MobileNet-v2, GoogLeNet, Resnet-v2, Resnet50, Resnet101, Inception-v3, and the like. However, the present disclosure is not limited to the above-described models. In addition, the neural network model 110a may be a multimodal or an ensemble model based on at least two different models.

Hereinafter, an inference process performed by the exemplary neural network model 110a will be described.

The neural network model 110a is an exemplary deep neural network model including an input layer 110a-1, a first connection network 110a-2, a first hidden layer 110a-3, a second connection network 110a-4, a second hidden layer 110a-5, a third connection network 110a-6, and an output layer 110a-7. However, the present disclosure is not limited to the neural network model illustrated in FIG. 1. The first hidden layer 110a-3 and the second hidden layer 110a-5 may also be referred to as a plurality of hidden layers.

The input layer 110a-1 may exemplarily include an input node x1 and an input node x2. That is, the input layer 110a-1 may include information on two input values.

The first connection network 110a-2 may exemplarily include information on six weight values for connecting each node of the input layer 110a-1 to each node of the first hidden layer 110a-3. Each weight value is multiplied by an input node value, and an accumulated value of the multiplied values is stored in the first hidden layer 110a-3. The weight value and the input node value may be referred to as parameters of the neural network model.

The first hidden layer 110a-3 may exemplarily include a node a1, a node a2, and a node a3. That is, the first hidden layer 110a-3 may include information on three node values.

A first processing element PE1 of FIG. 1 may process an operation of the node a1.

A second processing element PE2 of FIG. 1 may process an operation of the node a2.

A third processing element PE3 of FIG. 1 may process an operation of the node a3. The second connection network 110a-4 may exemplarily include information on nine weight values for connecting each node of the first hidden layer 110a-3 to each node of the second hidden layer 110a-5. The weight value of the second connection network 110a-4 is respectively multiplied by a node value input from the first hidden layer 110a-3, and an accumulated value of the multiplied values is stored in the second hidden layer 110a-5.

The second hidden layer 110a-5 may exemplarily include a node b1, a node b2, and a node b3. That is, the second hidden layer 110a-5 may include information on three node values.

A fourth processing element PE4 of FIG. 1 may process an operation of the node b1.

A fifth processing element PE5 of FIG. 1 may process an operation of the node b2.

A sixth processing element PE6 of FIG. 1 may process an operation of the node b3.

The third connection network 110a-6 may exemplarily include information on six weight values for connecting each node of the second hidden layer 110a-5 and each node of the output layer 110a-7. The weight value of the third connection network 110a-6 is respectively multiplied by a node value input from the second hidden layer 110a-5, and an accumulated value of the multiplied values is stored in the output layer 110a-7.

The output layer 110a-7 may exemplarily include a node y1 and a node y2. That is, the output layer 110a-7 may include information on two node values.

A seventh processing element PE7 of FIG. 1 may process an operation of the node y1.

An eighth processing element PE8 of FIG. 1 may process an operation of the node y2.

Each node may correspond to a feature value, and the feature value may correspond to a feature map.

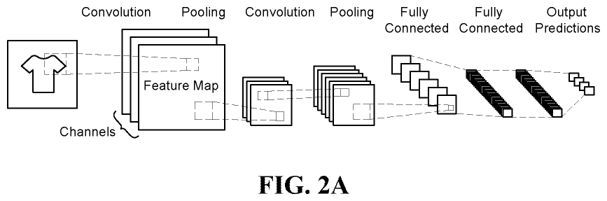

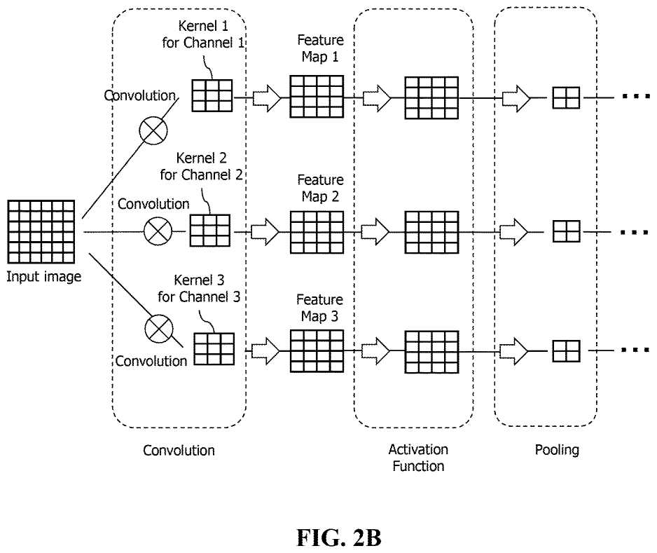

FIG. 2A is a diagram for describing a basic structure of a convolutional neural network (CNN).

Referring to FIG. 2A, an input image may be displayed as a two-dimensional matrix composed of rows of a specific size and columns of a specific size. The input image may have a plurality of channels, where a channel may indicate the number of color components of an input data image.

A convolution process means performing a convolution operation with a kernel while traversing the input image at specified intervals.

The convolutional neural network may have a structure that transfers an output value (convolution or matrix multiplication) of a current layer as an input value of a next layer.

For example, the convolution is defined by two main parameters (an input feature map and a kernel). The parameters of the neural network model may include the input feature map, an output feature map, an activation map, a weight, the kernel, an attention score (Q, K, V), and the like.

The convolution slides a kernel window over the input feature map. A step size by which the kernel slides the input feature map is referred to as a stride.

Pooling may be applied after the convolution. In addition, a fully-connected (FC) layer may be disposed at an end of the convolutional neural network.

However, the neural network model of the present disclosure is not limited to the CNN.

FIG. 2B is a comprehensive diagram illustrating operations of the convolutional neural network for easy understanding.

Referring to FIG. 2B, an input image is exemplarily shown as a two-dimensional matrix having a size of 6×6. In addition, FIG. 2B exemplarily illustrates that three nodes, that is, a channel 1, a channel 2, and a channel 3, are used.

First, the convolution operation will be described.

The input image (exemplarily shown as having the size of 6×6 in FIG. 2B) is convoluted with a kernel 1 for the channel 1 (exemplarily shown as having a size of 3×3 in FIG. 2B) in a first node, and as a result, a feature map 1 (exemplarily shown as having a size of 4×4 in FIG. 2B) is output. In addition, the input image (exemplarily shown as having the size of 6×6 in FIG. 2B) is convoluted with a kernel 2 for the channel 2 (exemplarily shown as having the size of 3×3 in FIG. 2B) in a second node, and as a result, a feature map 2 (exemplarily shown as having the size of 4×4 in FIG. 2B) is output. In addition, the input image is convoluted with a kernel 3 for the channel 3 (exemplarily shown as having the size of 3×3 in FIG. 2B) in a third node, and as a result, a feature map 3 (exemplarily shown as having the size of 4×4 in FIG. 2B) is output.

In order to process each convolution, the processing elements PE1 to PE12 of the neural processing unit 100 are configured to perform a multiply and accumulate (MAC) operation.

Next, an operation of the activation function will be described.

An activation function may be applied to the feature map 1, the feature map 2, and the feature map 3 (each size is exemplarily shown as 4×4 in FIG. 2B) output from the convolution operation. An output after the activation function is applied may exemplarily have the size of 4×4.

Next, the pooling operation will be described.

The feature map 1, the feature map 2, and the feature map 3 (each size is exemplarily shown as 4×4 in FIG. 2B) output from the activation function are input to three nodes. The pooling may be performed by receiving the feature maps output from the activation function as inputs. The pooling may reduce a size or emphasize a specific value in a matrix. A pooling method includes max pooling, average pooling, and min pooling. The max pooling is used to collect a maximum value among values in a specific region of the matrix, and the average pooling may be used to obtain an average within the specific region.

In the example of FIG. 2B, it is shown that the feature map having the size of 4×4 is reduced to a size of 2×2 by the pooling.

Specifically, the first node receives the feature map 1 for the channel 1 as an input, performs the pooling, and outputs it as, for example, a 2×2 matrix. The second node receives the feature map 2 for the channel 2 as an input, performs the pooling, and outputs it as, for example, a 2×2 matrix. The third node receives the feature map 3 for the channel 3 as an input, performs the pooling, and outputs it as, for example, a 2×2 matrix.

The above-described convolution, activation function, and pooling are repeated, and may be finally output to a fully connected layer. The corresponding output may be input back to the artificial neural network for image recognition. However, the present disclosure is not limited to the sizes of the feature map and the kernel.

The CNN described so far is the most frequently used method in a computer vision field among various deep neural network (DNN) methods. In particular, the CNN has shown remarkable performance in various research areas performing various tasks such as image classification and object detection.

However, the neural network model of the present disclosure is not limited to the CNN, and the neural processing unit (NPU) may process various neural network models.

### <Hardware Resources Required for Operations of ANN>

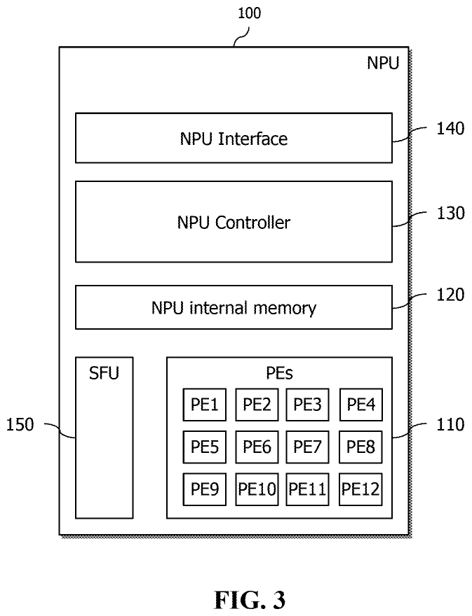

FIG. 3 is a block diagram of a neural processing unit according to an example of the present disclosure.

The neural processing unit 100 illustrated in FIG. 3 is a processor specialized to perform operations for an artificial neural network.

An artificial neural network means a network of artificial neurons that, when multiple inputs or stimuli are received, respectively multiplies and adds weights, transforms a value obtained by additionally adding a bias through an activation function, and transfers the transformed value. The artificial neural network trained in this way may be used to output an inference result from input data.

The neural processing unit 100 may be a semiconductor implemented with electric/electronic circuits. The electric/electronic circuits may mean including numerous electronic devices (e.g., a transistor, a capacitor).

In a case of a neural network model based on a transformer and/or a CNN, the neural processing unit 100 may selectively process a matrix multiplication operation, a convolution operation, and the like according to an architecture of the artificial neural network.

For example, in each layer of the convolutional neural network, an input feature map corresponding to input data and a kernel corresponding to a weight may be a tensor or a matrix composed of a plurality of channels. A convolution operation of the input feature map and the kernel is performed, and a convolution operation and a pooling output feature map are generated in each channel. An activation map of a corresponding channel is generated by applying an activation function to the output feature map. Thereafter, pooling for the activation map may be applied. Herein, the activation map may be comprehensively referred to as an output feature map. Hereinafter, for convenience of description, the activation map is referred to as an output feature map and described.

However, the examples of the present disclosure are not limited thereto, and the output feature map means that a matrix multiplication operation or a convolution operation is applied.

To further explain, the output feature map according to the examples of the present disclosure should be interpreted in a comprehensive meaning. For example, the output feature map may be a result value of a matrix multiplication operation or a convolution operation. Accordingly, it is also possible for the processing core 110 to be modified and implemented to further include a processing circuit unit for an additional algorithm. That is, it is also possible to be configured such that some circuit units of a special function unit 150 to be described later are included in the processing core 110.

The neural processing unit 100 may be configured to include the processing core 110 for processing the convolution and the matrix multiplication required for the above-described artificial neural network operation.

According to an embodiment, the processing core 110 may include a plurality of processing elements (PEs). According to an embodiment, the processing core may include at least one adder tree. Alternatively, the processing core may include a plurality of processing elements and at least one adder tree. Although the processing core is described as including the processing elements as a representative embodiment in the present specification, it is apparent that the processing core may further include other components such as the adder tree or may be replaced with other components due to technological development and design changes.

The neural processing unit 100 may be configured to include respective processing circuits optimized for a matrix multiplication operation, a convolution operation, an activation function operation, a pooling operation, a stride operation, a batch normalization operation, a skip connection operation, a concatenation operation, a quantization operation, a dequantization operation, a softmax function operation, a clipping operation, and a padding operation necessary for the above-described artificial neural network operation.

For example, the neural processing unit 100 may be configured to include a special function unit 150 for processing at least one of the activation function operations, the pooling operation, the stride operation, the batch normalization operation, the skip connection operation, the concatenation operation, the quantization operation, the clipping operation, and the padding operation among the above-described algorithms.

Specifically, the neural processing unit 100 may include the processing core 110, the special function unit 150, an NPU internal memory 120, an NPU controller 130, and an NPU interface 140. Each of the processing core 110, the special function unit 150, the NPU internal memory 120, the NPU controller 130, and the NPU interface 140 may be a semiconductor circuit to which numerous transistors are connected. Therefore, some of them may be difficult to visually identify and distinguish, and may be identified only by operation.

For example, a random circuit may operate as the processing core 110 or may be operated as the NPU controller 130. The NPU controller 130 may be configured to perform a function of a control unit configured to control an artificial neural network inference operation of the neural processing unit 100.

The neural processing unit 100 may include the NPU internal memory 120 configured to store parameters of a neural network model that may be inferred in the processing core 110 and the special function unit 150, and the NPU controller 130 configured to control an operation schedule of the processing core 110, the special function unit 150, and the NPU internal memory 120.

The neural processing unit 100 may be configured to process a feature map corresponding to an encoding and decoding method using scalable video coding (SVC) or scalable feature-map coding (SFC). The methods are technologies for variably changing a data transmission amount according to an effective bandwidth and a signal-to-noise ratio (SNR) of a communication channel or a communication bus. That is, the neural processing unit 100 may also be configured to further include an encoder and a decoder.

The processing core 110 may perform a part of an operation for the artificial neural network.

The special function unit 150 may perform another part of the operation for the artificial neural network.

The neural processing unit 100 may be configured to accelerate an operation of the neural network model based on hardware using the processing core 110 and the special function unit 150.

The NPU interface 140 may communicate with various components connected to the neural processing unit 100 through a system bus, for example, a memory. Herein, the memory may be a dedicated memory for the NPU. Herein, the dedicated memory may be a memory circuit included in the same package as the NPU.

The NPU controller 130 may be configured to control an operation of the processing core 110 for the inference operation of the neural processing unit 100, an operation of the special function unit 150, and a read and write order of the NPU internal memory 120. For example, the NPU controller 130 may be configured to schedule a neural network operation or control each circuit unit of the neural processing unit 100 in a scheduled order.

The NPU controller 130 may be configured to control the processing core 110, the special function unit 150, and the NPU internal memory 120 based on data locality information or information on an architecture of the neural network model.

The NPU controller 130 may analyze an architecture of the neural network model to be operated in the processing core 110 and the special function unit 150, or may receive previously analyzed information. The analyzed information may be information generated by a compiler. For example, data of an artificial neural network that the neural network model may include may include at least a portion of node data of each layer (that is, a feature map), arrangement data of layers, locality information or information on an architecture, and weight data of each connection network connecting nodes of each layer (that is, a weight kernel). The data of the artificial neural network may be stored in a memory provided inside the NPU controller 130 or the NPU internal memory 120. However, it is not limited thereto, and the data of the artificial neural network may be stored in a separate cache memory or register file provided in the NPU or a system on chip (SoC) including the NPU.

The NPU controller 130 may schedule an operation order of the neural network model to be performed by the neural processing unit 100 based on the data locality information or the information on the architecture of the neural network model.

The NPU controller 130 may receive scheduling information of an operation order of the neural network model to be performed by the neural processing unit 100 based on data locality information or information on an architecture of a compiled neural network model. For example, the scheduling information may be information generated by a compiler. The scheduling information generated by the compiler may be referred to as a machine code or a binary code.

That is, scheduling information utilized in the NPU controller 130 may be information generated by the compiler based on data locality information or a structure of the neural network model.

To elaborate, the compiler may efficiently schedule the NPU depending on how well it understands and reconstructs artificial neural network data locality, which is a unique characteristic of the neural network model.

To elaborate, the compiler may efficiently schedule the NPU depending on how well it understands a hardware architecture and performance of the neural processing unit 100.

To elaborate, when the neural network model is compiled by the compiler to be executed in the neural processing unit 100, the artificial neural network data locality may be reconstructed. The artificial neural network data locality may be reconstructed according to algorithms applied to the neural network model and operating characteristics of the processor.

To elaborate, the artificial neural network data locality may be reconstructed according to a method in which the neural processing unit 100 processes a corresponding neural network model, for example, feature map tiling or a stationary method of the processing core.

To elaborate, the artificial neural network data locality may be reconstructed according to the number of processing elements in the processing core 100 and a capacity of the internal memory.

To elaborate, the artificial neural network data locality may be reconstructed according to a bandwidth of a memory communicating with the neural processing unit 100.

This is because, due to each of the above-described factors, even when the same neural network model is operated and processed, the neural processing unit 100 may differently determine an order of necessary data every moment on a clock basis.

The compiler may determine data locality based on an operation order of a layer of the artificial neural network, a unit convolution, and/or a matrix multiplication for an order of data necessary for the operation of the neural network model, and may generate a compiled machine code.

The compiler may be separate software operating outside the NPU or an embedded compiler operating inside the NPU.

The NPU controller 130 may be configured to utilize scheduling information included in the machine code.

The NPU controller 130 may obtain a memory address value at which the feature map and the weight data of the layer of the neural network model are stored, based on the scheduling information. Herein, the address value may include an address value of the NPU internal memory and/or an address value of the dedicated memory.

For example, the NPU controller 130 may obtain a memory address value at which the feature map and the weight data of the layer of the neural network model stored in a memory (e.g., the NPU internal memory or the dedicated memory) are stored. Therefore, the NPU controller 130 may retrieve an activation parameter and a weight parameter of the layer of the neural network model to be driven from the dedicated memory, and may store the retrieved parameters in the NPU internal memory 120.

The activation parameter of each layer may have each corresponding memory address value.

Each weight parameter may have each corresponding memory address value.

The NPU controller 130 may be provided with scheduling information on an operation order of the processing core 110 based on data locality information or information on a structure of the neural network model, for example, arrangement data of layers of the artificial neural network of the neural network model, locality information, or information on a structure. A scheduling order may be determined in a compiling stage or may be determined in real time.

Since the NPU controller 130 operates based on information scheduled based on the data locality information or the information on the structure of the neural network model, the NPU controller 130 may operate differently from a scheduling concept of a general CPU. The scheduling of the general CPU operates to produce the best efficiency in consideration of fairness, efficiency, stability, reaction time, and the like. That is, scheduling is performed to perform the most processing within the same time in consideration of priority, calculation time, and the like.

A conventional CPU used an algorithm for scheduling tasks in consideration of data such as a priority order of each processing and an operation processing time.

Unlike this, the NPU controller 130 may control the neural processing unit 100 in a processing order of the neural processing unit 100 determined based on the data locality information or the information on the structure of the neural network model.

Furthermore, the NPU controller 130 may drive the NPU 100 in a processing order determined based on the data locality information or the information on the structure of the neural network model and/or the data locality information or the information on the structure of the neural processing unit 100 to be used.

However, the present disclosure is not limited to the data locality information or the information on the structure of the neural processing unit 100.

The NPU controller 130 may be configured to store data locality information or information on a structure of an artificial neural network.

That is, the NPU controller 130 may determine the processing order even by utilizing at least only the data locality information or the information on the structure of the artificial neural network of the neural network model.

Furthermore, the NPU controller 130 may determine the processing order of the neural processing unit 100 in consideration of the data locality information or the information on the structure of the neural network model and the data locality information or the information on the structure of the neural processing unit 100. In addition, processing optimization of the neural processing unit 100 in the determined processing order is also possible.

That is, the NPU controller 130 may be configured to operate based on a machine code compiled from the compiler, but in another example, the NPU controller 130 may also be configured to embed an embedded compiler. According to the above-described configuration, the neural processing unit 100 may be configured to receive a file in a format of a framework of various AI software and generate a machine code. For example, the framework of AI software includes TensorFlow, PyTorch, Keras, XGBoost, mxnet, DARKNET, ONNX, and the like.

The processing core 110 refers to a configuration in which a plurality of processing elements PE1 to PE12 configured to operate a feature map and weight data of the artificial neural network are arranged. Each processing element may include a multiply and accumulate (MAC) operator and/or an arithmetic logic unit (ALU) operator. However, examples according to the present disclosure are not limited thereto.

Each processing element may be configured to optionally further include an additional special function unit to process an additional special function.

For example, the processing core 110 may also be modified and implemented to further include a batch normalization unit, an activation function unit, an interpolation unit, and the like.

The special function unit 150 may include a circuit unit configured to select and process an activation function operation, a pooling operation, a stride operation, a batch normalization operation, a skip connection operation, a concatenation operation, a quantization operation, a clipping operation, a padding operation, and the like according to an architecture of an artificial neural network. That is, the special function unit 150 may include a plurality of special function operation processing circuit units.

The processing core 110 is configured to include a plurality of processing elements PE1 to PE12. The plurality of processing elements PE1 to PE12 illustrated in FIG. 3 are merely examples for convenience of description, and the number of the plurality of processing elements PE1 to PE12 is not limited. A size or the number of the processing core 110 may be determined by the number of the plurality of processing elements PE1 to PE12. The size of the processing core 110 may be implemented in an N×M matrix form. Herein, N and M are integers greater than 0. The processing core 110 may include N×M processing elements. That is, there may be one or more processing elements.

The size of the processing core 110 may be designed in consideration of characteristics of the neural network model on which the neural processing unit 100 operates.

The processing core 110 is configured to perform functions such as addition, multiplication, and accumulation necessary for artificial neural network operations. In other words, the processing core 110 may be configured to perform a multiply and accumulate (MAC) operation.

Although the processing core is illustrated as including a plurality of processing elements in FIG. 3, operators implemented with a plurality of multipliers and an adder tree may be arranged in parallel to be configured. In this case, the processing core 110 may also be referred to as at least one processing element including a plurality of operators.

Hereinafter, the first processing element PE1 of the processing core 110 will be described as an example.

The neural processing unit 100 according to the examples of the present disclosure may be referred to as an AI semiconductor chip, an AI accelerator, a neural processor chip, and the like.

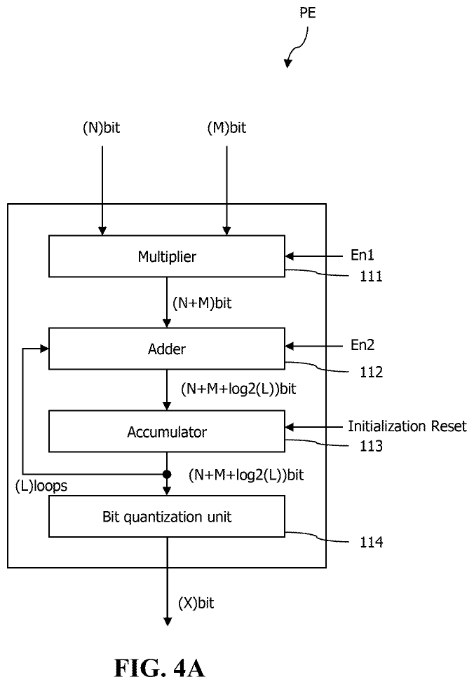

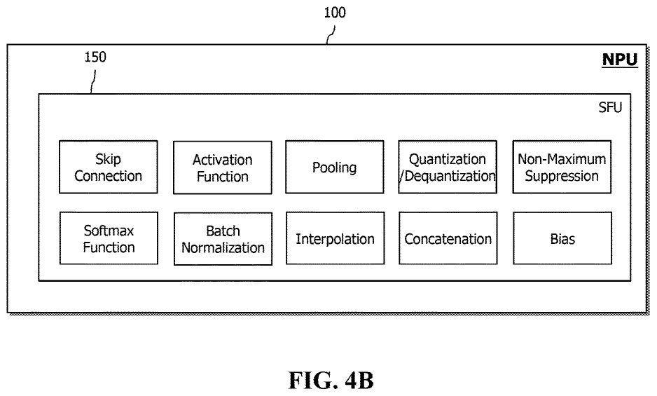

FIG. 4A is a schematic conceptual diagram illustrating one processing element applicable to an example of the present disclosure.

Referring to FIG. 4A, the processing element PE may be configured to include a multiplier 111, an adder 112, an accumulator 113, and a bit quantization unit 114. However, examples according to the present disclosure are not limited thereto, and a plurality of processing elements may be modified and implemented in consideration of calculation characteristics of a neural network model.

The multiplier 111 multiplies received (N) bit data and (M) bit data. A calculation value of the multiplier 111 is output as (N+M) bit data. Herein, N and M are integers greater than 0. A first input unit receiving the (N) bit data may be configured to receive a variable parameter, and a second input unit receiving the (M) bit data may be configured to receive a constant parameter. However, input data of the multiplier 111 is not limited to a specific parameter. For example, it may be said that a weight parameter for which learning is completed in the neural network model has constant characteristics based on the processing element. For example, an input value (e.g., an activation parameter, a feature map parameter, an attention parameter, a KV cache parameter, etc.) calculated with a weight in the neural network model may be said to have variable characteristics based on the processing element.

That is, according to the examples of the present disclosure, since the input data of the processing element may operate by understanding the characteristics of a constant value and a variable value, the calculation efficiency of the neural processing unit 100 may be improved. However, the neural processing unit 100 is not limited to the characteristics of the constant value and the variable value of the input data.

Herein, a meaning of a value having a characteristic like a variable or a meaning of a variable means that, in a case of a value of a memory address where the corresponding value is stored, the corresponding value is updated whenever incoming input data is updated. For example, node data of each layer may be a MAC calculation value in which weight data of a neural network model is reflected, and when object recognition of video data is inferred with the corresponding neural network model, an input image changes every frame, so that the node data of each layer changes.

Herein, a meaning of a value having a characteristic like a constant or a meaning of a constant means that, in a case of a value of a memory address where the corresponding value is stored, the corresponding value is preserved regardless of an update of incoming input data. For example, weight data of a connection network is a unique inference criterion of a neural network model, and even when object recognition of video data is inferred with the corresponding neural network model, the weight data of the connection network may not change.

That is, the multiplier 111 may be configured to receive one variable and one constant. To elaborate, a variable value input to the first input unit may be node data of a layer of a neural network model, and the node data may be input data of an input layer, an accumulated value of a hidden layer, and an accumulated value of an output layer of the neural network model. A constant value input to the second input unit may be weight data of a connection network of the neural network model.

The NPU controller 130 may be configured to improve a memory reuse rate in consideration of a characteristic of a constant value.

A variable value is an operation value of each layer, and the NPU controller 130 may recognize a reusable variable value based on a machine code of a compiled neural network model, and may control the NPU internal memory 120 to reuse a memory.

A constant value is weight data of each connection network, and the NPU controller 130 may recognize a constant value of a connection network repeatedly used based on structural data of a neural network model or neural network data locality information, and may control the NPU internal memory 120 to reuse parameters stored in the NPU internal memory 120. A meaning of reusing the parameters is to use the parameters stored in the NPU internal memory 120 again in a next operation without deleting the parameters or copying or moving the parameters to a dedicated memory 3000. According to the above-described configuration, as illustrated in FIG. 4A, there is an effect capable of preventing power consumption according to an operation of a main memory 3000 from being consumed. In addition, there is an effect capable of removing a delay time occurring when the neural processing unit 100 transmits data to and from the main memory 3000.

That is, the NPU controller 130 may know a reusable variable value and a reusable constant value based on a machine code of a compiled neural network model. Accordingly, the NPU controller 130 may be configured to control the NPU internal memory 120 to reuse parameters stored in the memory.

Because the processing element knows a fact that when 0 is input to one input unit among the first input unit and the second input unit of the multiplier 111, an operation result becomes 0 even without performing an operation, the processing element may limit an operation such that the multiplier 111 does not perform the operation.

For example, when 0 is input to one input unit among the first input unit and the second input unit of the multiplier 111, the multiplier 111 may be configured to operate in a zero-skipping method.

Each processing element PE included in the processing core 110 may be respectively activated or deactivated for zero-skipping. The NPU controller 130 may be configured to provide an activation or deactivation signal to each processing element PE on a clock basis. Herein, when the processing element PE is deactivated, the multiplier 111 may be configured to be deactivated according to a level of a first enable signal En1. Accordingly, power consumed for an operation of the multiplier 111 may be reduced. For example, information on power consumption of the multiplier may refer to FIG. 4.

Each processing element PE may be respectively activated or deactivated for zero-skipping. The NPU controller 130 may be configured to provide an activation or deactivation signal to each processing element PE on a clock basis. Herein, when the processing element PE is deactivated, the adder 112 may be configured to be deactivated according to a level of a second enable signal En2. Accordingly, power consumed for an operation of the adder 112 may be reduced. For example, information on power consumption of the adder may refer to FIG. 4. In some examples, each processing element PE may be designed to receive each control signal for zero-skipping operation control (i.e., activation or deactivation) from the NPU controller 130.

In some examples, each multiplier 111 of each processing element PE may be designed to receive each control signal for zero-skipping operation control from the NPU controller 130. According to the above-described configuration, power consumption of a multiplier may be reduced by zero-skipping.

In some examples, each adder 112 of each processing element PE may be designed to receive each control signal for zero-skipping operation control from the NPU controller 130. According to the above-described configuration, power consumption of an adder may be reduced by zero-skipping.

In some examples, each multiplier 111 and each adder 112 of each processing element PE may be designed to simultaneously receive each control signal for zero-skipping operation control from the NPU controller 130. According to the above-described configuration, power consumption of a multiplier and an adder may be reduced by zero-skipping.

In some examples, a weight is a constant value of which learning is completed, and a machine code in which a neural network model including the weight is compiled may be programmed to input each control signal for zero-skipping operation control to each processing element PE into which values having a weight of 0 are input.

The number of bits of data input to the first input unit and the second input unit may be determined according to quantization of node data and weight data of each layer of the neural network model.

For example, node data of a first layer may be quantized to 5 bits, and weight data of the first layer may be quantized to 7 bits. In this case, the first input unit may be configured to receive 5-bit data, and the second input unit may be configured to receive 7-bit data. That is, the number of bits of data input to each input unit may be different from each other.

The processing element PE may be configured to be provided with quantization information of data input to each input unit. Neural network data locality information may include quantization information of input data and output data of the processing element PE.

The neural processing unit 100 may control the quantized number of bits to be transformed in real time when quantized data stored in the NPU internal memory 120 is input to the input units of the processing element. That is, the quantized number of bits may be different for each layer, and the processing element may be configured to receive bit number information from the neural processing unit 100 in real time when the number of bits of the input data is transformed, and transform the number of bits in real time to generate the input data.

The accumulator 113 accumulates a calculation value of the multiplier 111 and a calculation value of the accumulator 113 using the adder 112 as many times as the number of (L) loops. Accordingly, the number of bits of data of an output unit and an input unit of the accumulator 113 may be output as (N+M+log 2(L)) bits. Herein, L is an integer greater than 0.

When the accumulation is completed, the accumulator 113 may receive an initialization reset signal to initialize data stored inside the accumulator 113 to 0. However, examples according to the present disclosure are not limited thereto.

The accumulator 113 is configured to store the accumulated value even when zero-skipping is activated in the corresponding processing element PE. Therefore, even if the zero-skipping is activated, subsequent values may be accumulated.

The bit quantization unit 114 may reduce the number of bits of data output from the accumulator 113. The bit quantization unit 114 may be controlled by the NPU controller 130. The number of bits of the quantized data may be output as (X) bits. Herein, X is an integer greater than 0. According to the above-described configuration, the plurality of processing elements is configured to perform a multiply and accumulate (MAC) operation, and the plurality of processing elements have an effect of quantizing and outputting a MAC operation result. In particular, this quantization has an effect of further reducing power consumption as the (L) loops increase. In addition, when power consumption is reduced, there is an effect of reducing heat generation of an edge device. In particular, reducing the heat generation has an effect of reducing a possibility of malfunction occurring due to a high temperature of the neural processing unit 100.

Output data of (X) bits of the bit quantization unit 114 may be node data of a next layer or input data of convolution. If the neural network model is quantized, the bit quantization unit 114 may be configured to be provided with quantized information from the neural network model. However, the present disclosure is not limited thereto, and the NPU controller 130 may also be configured to analyze the neural network model to extract the quantized information. Accordingly, the output data of (X) bits may be converted to the quantized number of bits to be output to correspond to a size of the quantized data. The output data of (X) bits of the bit quantization unit 114 may be stored in the NPU internal memory 120 with the quantized number of bits.

The plurality of processing elements of the neural processing unit 100 according to an example of the present disclosure may include the multiplier 111, the adder 112, the accumulator 113, and the bit quantization unit 114. The plurality of processing elements may reduce the number of bits of data of (N+M+log 2(L)) bits output from the accumulator 113 to the number of bits of (X) bits by the bit quantization unit 114. The NPU controller 130 may control the bit quantization unit 114 to reduce the number of bits of the output data by a predetermined number of bits from a least significant bit (LSB) to a most significant bit (MSB). When the number of bits of the output data is reduced, there is an effect that power consumption, an operation amount, and memory usage may be reduced. However, when the number of bits is reduced below a specific length, a problem in which inference accuracy of the neural network model may be rapidly lowered may occur. Therefore, the reduction in the number of bits of the output data, that is, a quantization level may be determined by comparing a degree of reduction in the power consumption, the operation amount, and the memory usage to an inference accuracy reduction level of the neural network model. The determination of the quantization level may also be determined by determining a target inference accuracy of the neural network model and testing while gradually reducing the number of bits. The quantization level may be respectively determined for each layer of the neural network model.

According to the processing element PE described above, by adjusting the number of bits of the (N) bit data and the (M) bit data of the multiplier 111 and reducing the number of bits of the operation value of (X) bits by the bit quantization unit 114, the plurality of processing elements have an effect of reducing the power consumption while improving a multiply and accumulate (MAC) operation speed, and also have an effect of more efficiently performing a convolution operation of the neural network model.

FIG. 4B is a schematic conceptual diagram illustrating a special function unit (SFU) applicable to an example of the present disclosure.

Referring to FIG. 4B, the special function unit 150 may include various functional units. Each functional unit may be selectively operated. Each functional unit may be selectively turned on or turned off. That is, each functional unit is configurable.

In other words, the special function unit 150 may include various circuit units necessary for an artificial neural network inference operation.

For example, the circuit units of the special function unit 150 may include a functional unit for a skip connection operation, a functional unit for an activation function operation, a functional unit for a pooling operation, a functional unit for a quantization/dequantization operation, a functional unit for a non-maximum suppression (NMS) operation, a functional unit for a softmax function operation, a functional unit for a batch normalization operation, a functional unit for an interpolation operation, a functional unit for a concatenation operation, a functional unit for a bias operation, and the like.

The functional units of the special function unit 150 may be selectively turned on or turned off by the data locality information of the neural network model. The data locality information of the neural network model may include control information related to a turn-off or turn-off of a corresponding functional unit when an operation for a specific layer is performed.

An activated unit among the functional units of the special function unit 150 may be turned on. When some functional units of the special function unit 150 are selectively turned off in this way, the power consumption of the neural processing unit 100 may be reduced. Meanwhile, power gating may be utilized in order to turn off some functional units. Alternatively, clock gating may be performed in order to turn off some functional units.

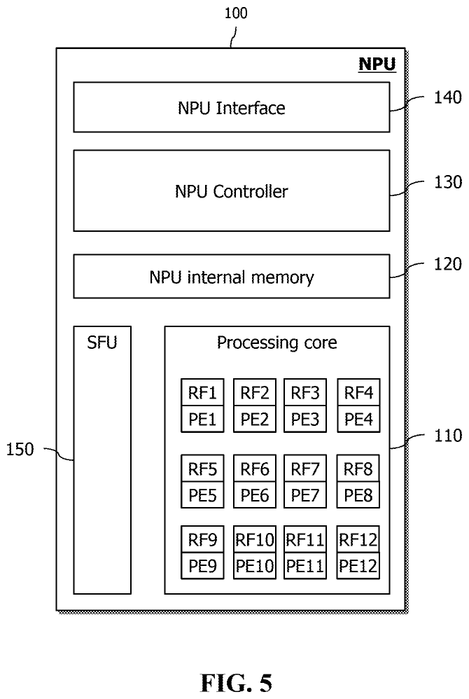

FIG. 5 is an exemplary diagram illustrating a modified example of the neural processing unit 100 illustrated in FIG. 3.

Compared to the neural processing unit 100 exemplarily illustrated in FIG. 3, the neural processing unit 100 illustrated in FIG. 5 is substantially the same except for the processing core 110, and thus, duplicate descriptions may be omitted hereinafter merely for convenience of description.

The processing core 110 exemplarily illustrated in FIG. 5 may further include respective register files RF1 to R1F12 corresponding to the respective processing elements PE1 to PE12 in addition to the plurality of processing elements PE1 to PE12.

The plurality of processing elements PE1 to PE12 and the plurality of register files RF1 to RF12 illustrated in FIG. 5 are merely examples for convenience of description, and the number of the plurality of processing elements PE1 to PE12 and the plurality of register files RF1 to RF12 is not limited.

A size or the number of the processing core 110 may be determined by the number of the plurality of processing elements PE1 to PE12 and the plurality of register files RF1 to RF12. The sizes of the processing core 110 and the plurality of register files RF1 to RF12 may be implemented in an N×M matrix form. Herein, N and M are integers greater than 0.

The size of the processing core 110 may be designed in consideration of characteristics of the neural network model on which the neural processing unit 100 operates. To elaborate, a memory size of a register file may be determined in consideration of a data size of a neural network model to be operated, a required operation speed, a required power consumption, and the like.

The register files RF1 to RF12 of the neural processing unit 100 are static memory units directly connected to the processing elements PE1 to PE12. The register files RF1 to RF12 may include, for example, a flip-flop and/or a latch. The register files RF1 to RF12 may be configured to store a multiply and accumulate (MAC) operation value of the corresponding processing elements PE1 to PE12. The register files RF1 to RF12 may be configured to provide weight data and/or node data to the NPU internal memory 120 or receive the weight data and/or the node data from the NPU internal memory 120.

The register files RF1 to RF12 may also be configured to perform a function of a temporary memory of an accumulator during a MAC operation.

The neural processing unit 100 according to the examples of the present disclosure may be referred to as an artificial intelligence (AI) semiconductor chip, an AI accelerator, a neural processor chip, and the like.

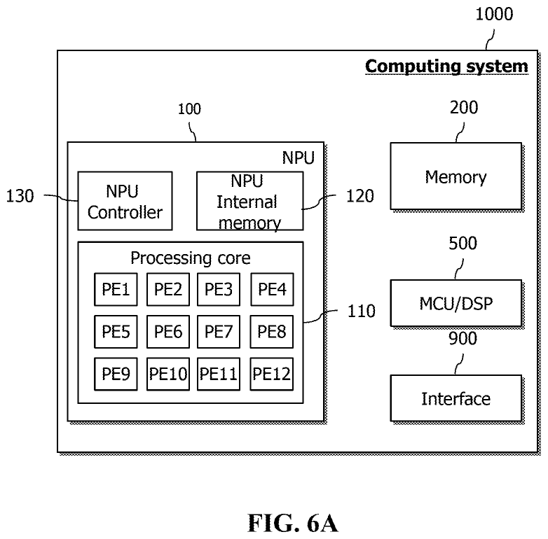

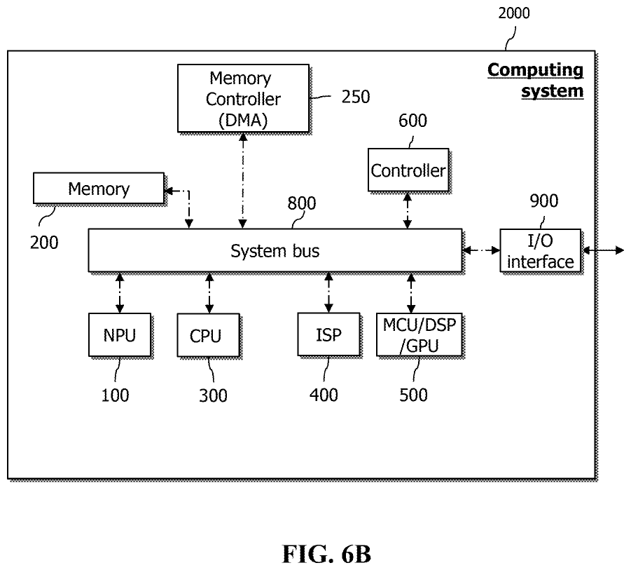

FIG. 6a is a block diagram illustrating a computer system according to an example, and FIG. 6b is a block diagram illustrating a computer system according to another example.

Referring to FIG. 6a, a computer system 1000 may include one or more NPUs 100 mounted on a substrate, one or more memories 200, one or more micro controller units (MCUs)/digital signal processors (DSPs) 500, and an input/output (I/O) interface 900. Herein, an NPU and a CPU may be integrated into one semiconductor chip or implemented as a chiplet.

The I/O interface 900 may obtain input data from a user. The input data may include text data, voice data, or video data input by the user, but is not limited thereto. As an example, the user may input a prompt such as ‘make a tutorial video on the topic of the basics of an artificial intelligence semiconductor’. The input data input by the user may be transmitted to the I/O interface 900 based on wired or wireless communication.

Output data (output) may be generated by using an artificial intelligence model based on an artificial neural network on the input data, and the output data may be transmitted to the outside through the I/O interface 900. The output data may include, for example, video data, text data, voice data, and the like, but is not limited thereto. Types of the input data and the output data may be different. For example, the input data may be text and the output data may be a video. The video data may be two-dimensional or three-dimensional tensor data.

The one or more memories 200 may store a result of compiling the artificial intelligence model based on the artificial neural network. The one or more memories 200 may be a dynamic random-access memory (DRAM) and may be located outside the NPU 100. The artificial intelligence model may include StyleGAN (style-based generative adversarial network), VQGAN (vector quantized generative adversarial network), or Stable Diffusion, but is not limited thereto.

The NPU 100 may generate the output data (output) by performing an inference operation on the input data using the compilation result.

As illustrated, the NPU 100 may include a controller 130 for controlling an operation of the NPU and scheduling the inference operation, a processing core 110 for performing the inference operation, and at least one internal memory 110 for storing at least some of parameters of the artificial neural network required for the inference operation. The at least one internal memory 110 may be, for example, a static random-access memory (SRAM), but is not limited thereto.

According to an embodiment, metadata enabling recognition of an origin of the output data may be added to the output data (output). The metadata enabling recognition of the origin may include any type of information indicating that the output generated by the NPU 100 is generated by the NPU 100. The metadata may include hardware identification information of the NPU 100, information on the artificial intelligence model, a date/time when the output is generated, user information transmitting the input data, the input data, and the like.

The hardware identification information may store metadata capable of identifying an electronic device (NP) such as manufacturer information, a product model name and a code, a serial number, a chip name, and a brand name of the NPU 100. The manufacturer information may include Intel, AMD, ARM, Qualcomm, NVIDIA, DEEPX, and the like. The product model name and the code may include Intel Core i7-12700K, AMD Ryzen 5800X, Jetson AGX Orin, DX-M1, and the like. The serial number is a uniquely assigned character string to identify a specific processor, and may be used for hardware identification, security, quality control, service provision, and the like. As an example, the serial number may include “10000000ab12cd34”, “GPU-1D47E931-3B22”, and the like.

The information on the artificial intelligence model may include a name, a family, a version, a learning method, a training version, a training date, a framework, a used learning dataset, and the like of the artificial intelligence model used for the inference to generate the output. For example, it may include YOLOv8, GPT-4 for text generation, Stable Diffusion for image generation, VALL-E for voice generation, MusicLM for music generation, Sora for video generation, and the like.

The user information transmitting the input data may include information capable of specifying the user, such as an ID and an IP address of the user.

The metadata may include the input data. As an example, a prompt input by the user may be included in the metadata.

According to a representative embodiment, the metadata may be expressed in a text form. The metadata may be displayed on the output in a watermark form to make it difficult for the user or a third party to forge, falsify, or delete it.

According to an embodiment, the metadata may be stored in the internal memory 120. Alternatively, the metadata may be stored in the one or more memories 200. The internal memory 130 or the one or more memories 200 may include a read-only nonvolatile memory for storing the hardware identification information.

The internal memory 120 for storing the metadata may be implemented as a read-only nonvolatile memory. In such an embodiment, the at least one internal memory 120 may be divided into a static random-access memory (SRAM) for loading and storing at least some of the parameters of the artificial neural network from the memory 200 outside the NPU 100 and a read-only nonvolatile memory for storing the metadata. The read-only nonvolatile memory may include a mask ROM, an OTP ROM, a PROM, or an eFuse, but is not limited thereto. When manufacturing the NPU 100 or manufacturing the computer system 1000, the hardware identification information may be recorded in the read-only nonvolatile memory. As the metadata is stored in the read-only nonvolatile memory, the metadata cannot be easily falsified or deleted. In addition, since the metadata is synthesized with the output data and output to the outside of the NPU 100, it is impossible for the user or the third party to separate the metadata from the output data to falsify or delete it. This is differentiated from a technology indicating that a creation produced based on generative artificial intelligence is generated by artificial intelligence by a post-processing method in a server, and has a feature that the metadata is not forged, falsified, or deleted by adding the metadata at the lowest level.

The controller 130 of the NPU 100 may add the metadata to the output data. As an example, if the output data is video data, the metadata may be synthesized with the video data such that the metadata is displayed on the output video in a watermark form. In such an embodiment, the video data in which the metadata is synthesized with the original video data through the interface 140 of the NPU 100 may be output to the outside through the interface 140. According to an embodiment, when the NPU 100 outputs the video data to the outside through the interface 140 together with the metadata read from the internal memory 120, the video data and the metadata may be transferred to the MCU/DSP 500, and the MCU/DSP 500 may synthesize the metadata with the video data such that the metadata is displayed on the video in a watermark form.

When it is determined that the output data is image data, the controller 130 may read the hardware identification information from the internal memory 120 and add the hardware identification information to the image data such that the hardware identification information is displayed on the image data in a watermark form when the image data is generated. According to an embodiment, if the artificial intelligence model is a StyleGAN (style-based generative adversarial network), a VQGAN (vector quantized generative adversarial network), or Stable Diffusion, the controller 130 may determine a type of the output data as the image data.

When the input data is a prompt input by the user and the output data is image data generated based on the prompt, the controller 130 may add the metadata to the image data such that the hardware identification information or the information on the artificial intelligence model is displayed on a final image shown to a person in a watermark form.

When the input data is a prompt input by the user and the output data is image data generated based on the prompt, the controller 130 may input the input data to the artificial intelligence model to obtain a script of a predetermined length and at least one reference video clip. In addition, technical tutorial video data may be obtained as the output data by mapping the script and the reference video clip. As an example, when the user inputs a prompt such as ‘make a tutorial video on the topic of the basics of an artificial intelligence semiconductor’, the NPU 100 may generate a technical tutorial video of a predetermined length (e.g., 1 minute) based on a generative artificial intelligence model. The NPU 100 may obtain the reference video clip and generate the script based on the prompt. The technical tutorial video may be generated by mapping the reference video clip and the script. The metadata may be added to the technical tutorial video data such that the metadata is displayed on a final technical tutorial video shown to people in a watermark form.

Referring to FIG. 6b, a computer system 2000 may include one or more NPUs 100, one or more memories 200, a memory controller 250, one or more CPUs 300, one or more image signal processors (ISPs) 400, one or more micro controller units (MCUs), digital signal processors (DSPs), or graphic processing units (GPUs) 500, a controller 600, a system bus 800, and an input/output (I/O) interface 900 mounted on a substrate. Herein, an NPU and a CPU may be integrated into one semiconductor chip or implemented as a chiplet.

However, it can be understood that a specific circuit among components of the computer system 2000 may be selectively excluded according to an operating scenario of a specific application requiring no specific function.

The system bus 800 may be implemented by an electrically conductive pattern formed on the substrate or a semiconductor die. The system bus 800 enables high-speed communication.

For example, the one or more NPUs 100, the one or more memories 200, the memory controller 250, the one or more CPUs 300, the one or more ISPs 400, and the one or more MCUs 500 may communicate through the system bus 800.

The one or more NPUs 100, the one or more memories 200, the memory controller 250, the one or more CPUs 300, the one or more ISPs 400, the one or more MCUs, DSPs, or GPUs 500, and the controller 600 may be semiconductors implemented as electric/electronic circuits. That is, the one or more NPUs 100, the one or more memories 200, the memory controller 250, the one or more CPUs 300, the one or more ISPs 400, the one or more MCUs, DSPs, or GPUs 500, and the controller 600 may be semiconductor circuits to which numerous electronic devices (e.g., a transistor, a capacitor) are connected.

The one or more NPUs 100, the one or more CPUs 300, the one or more ISPs 400, the one or more MCUs, DSPs, or GPUs 500, and the controller 600 make requests to the memory controller 250 through the system bus 500. Accordingly, the memory controller 250 may read or write data from or to the one or more memories 200.

Meanwhile, the computer system 1000 and the computer system 2000 illustrated in FIG. 6a or FIG. 6b may be implemented in a form of a system on chip (SoC). The SoC refers to a semiconductor containing an entire system on a single chip, and means a technology in which major semiconductor devices including a calculation memory data switching device are implemented on a single chip. A system in package (SiP) refers to a semiconductor containing an entire system in a single package, and means a technology in which major semiconductor devices including a calculation memory data switching device are implemented in a single package.

The NPU 100 according to the examples of the present disclosure may be referred to as an AI semiconductor, an AI accelerator, a neural processor chip, and the like. The computer system 1000 to the computer system 2000 including the NPU 100 according to the examples of the present disclosure may be referred to as an SoC, an AI processor package, an AI semiconductor, an AI accelerator, a neural processor chip, and the like.

The computer system 1000 to the computer system 2000 illustrated in FIG. 6a and FIG. 6b may include various components, and each component may perform an artificial intelligence operation while operating independently or cooperatively. According to structural flexibility and functional expandability of such a system, various pieces of additional information required for operating the system may be stored.

The metadata referred to in the present disclosure is one of such additional information, and may include identification information on components of the system, information on a model used for the artificial intelligence operation, or other information related to an operating environment. Such metadata may be stored inside the system and utilized together with an inference operation, or output to the outside and used in various application areas.

The metadata may be broadly classified into a text type and an image type. First, the text-type metadata may include formalized identification information on the system or the components of the system. For example, the text-type metadata may include information such as a system manufacturer name, a product name, a model name, a model code, a serial number, and the like, and such information serves as a standard for clearly identifying to which product the corresponding system or component corresponds and in what environment it operates. The text metadata may be utilized for various purposes, for example, as data for system maintenance, identification of a target device during a software update, copyright disputes, and securing legal traceability.

Such text metadata may be stored in the memory 200 of the computer system 1000. This is to enable the system to load the metadata from the corresponding memory during an initial operation and utilize the metadata for an internal operation or an external output. Alternatively, or supplementarily, the metadata may be stored in a local memory or an internal storage within each component. For example, hardware identification information corresponding to each of the one or more NPUs 100, the one or more CPUs 300, the one or more ISPs 400, or the one or more MCUs 500 may be stored inside the corresponding component. When the identification information is separately stored for each component in this way, independent management and tracking of each component in the system becomes possible, thereby improving operational efficiency and stability of the entire system.

In particular, when the hardware identification information is related to the NPU 100, the metadata may include a brand name, a model name, a model code, a serial number, and the like of the corresponding NPU. For example, if the NPU is a specific operation-specialized model of a specific manufacturer, a unique identifier therefor is directly connected to characteristics of the AI operation performed by the system, so providing such information together with an output result is greatly helpful for the user to determine the reliability of the corresponding result.

Meanwhile, according to an embodiment, the metadata may include identification information on an artificial intelligence model, that is, a neural network (hereinafter, NN). This is because an operation performed by the AI system depends on a specific neural network structure or version, so it is important to clearly know the identity of the corresponding model in understanding and utilizing a result value. The model identification information may include information such as a model family (e.g., CNN, Transformer, etc.), a model name (e.g., YOLO, ResNet, etc.), a model version, a training version, a training date, a framework, a used learning dataset, and the like. Such information may be usefully utilized in various fields including model performance evaluation, error cause analysis, version management, and legal proof.

As a specific example, the metadata may include the following model names: Chat-GPT, LLaMA, Stable Diffusion, a large language model (LLM), GAN, Florence, DaViT, MobileViT, Swin-Transformer, a general transformer, YOLO, CNN, PIDNet, BiseNet, RCNN, VGG, VGG16, DenseNet, SegNet, DeconvNet, DeepLab V3+, U-net, SqueezeNet, AlexNet, ResNetl8, MobileNet-v2, GoogLeNet, ResNet-v2, ResNet50, ResNetl01, Inception-v3, and the like. Such various pieces of model information clarify an origin for each operation result, and enable comparing or analyzing results based on which model is used even for the same input data.

The metadata including such model identification information may be stored in the memory 200 of the system, and may be stored in the internal memory 120 of the NPU 100 executing the corresponding model. As an example, artificial intelligence model information may be stored in the memory 200 and the hardware identification information of the NPU 100 may be stored in the internal memory 120. Alternatively, the artificial intelligence model information and the hardware identification information may be stored in the internal memory 120. Alternatively, the artificial intelligence model information and the hardware identification information may be stored in the memory 200. In this case, the corresponding metadata may be immediately referable at a time when an inference operation is performed, or may be configured to be automatically transmitted to the outside together with an output result.

On the other hand, the metadata may also be configured in an image type. The image-type metadata may be utilized as a visual identification means, which is advantageous for intuitively expressing information on system components or an artificial neural network model. For example, the metadata may be configured with a brand logo of a system manufacturer, a hardware label image, an image in which a model name or a serial number is inserted, or a barcode or QR code image configured to be automatically recognized by a machine. The image-type metadata may be efficiently used in UI/UX improvement, visual brand integration, or product identification automation.

Such image-type metadata may also be stored in a system memory or a component, and may be input to the NPU at the time of use or provided to the outside together with an output result. Furthermore, the image-type metadata may be synthesized with an input feature map of the NPU 100 and utilized in a manner of being input to the NPU. For example, when a cat image is provided as an input, a brand logo image of a manufacturer of the NPU is synthesized thereto to form one input image, and this image is input to the NPU. Such a synthesis method may be a means for explicitly including an operating situation or a calculation condition of the NPU, and may be usefully utilized when configuring learning or test data.

The metadata configured as above is not simply stored inside the system, but may be output to the outside together with an output of the NPU according to a core configuration of the present disclosure. That is, when the NPU outputs a result of performing operations including image analysis, object recognition, pattern classification, image generation, token generation, and the like, the metadata is output together so as to present from which hardware, which model, and which environment the corresponding result is derived. This is an important technical means enabling the user to comprehensively determine the reliability, accuracy, applicability, and the like of the result value.

According to a first embodiment, when the metadata is a text type, the corresponding text metadata may be output in parallel with an inference result of the NPU. For example, when the NPU performs object detection and classification in an image to derive a text result of “cat”, metadata including model identification information such as “MobileNet-v2/v3.1/Trained on ImageNet/2023-11-15” is output together with the text result. Such a method increases transparency of result interpretation and becomes an important standard when comparing and analyzing results between the same systems.

According to a second embodiment, when the metadata is an image type, the metadata may be synthesized with an input image of the NPU to be input to the NPU as a single feature map. For example, after an input image for object recognition is combined with an image in which a manufacturer logo of the NPU is inserted, this synthesized image is input to the NPU and computed.

In conclusion, the metadata according to the present disclosure goes beyond a simple auxiliary information level and acts as an essential component for securing structural reliability of a system and interpretability of an operation result. Through various embodiments of the present disclosure, the metadata may be stored in a system or an NPU in a text or image form, and by providing this together with an output result of the NPU, richer and highly reliable information may be provided to a system user or a linked system. Such a metadata output method may make a practical contribution to verification of artificial intelligence systems, maintenance, improvement of user experience, origin indication, copyright disputes, distinction between what is done by humans and what is done by artificial intelligence, and the like in the future.

One of the important technical features according to the present disclosure is that the metadata is not simply stored in the system, but may be output to the outside together with an output of the NPU 100. This acts as a core function to more clearly deliver a meaning of result data in an artificial intelligence-based system, ensure or recognize its reliability and origin, and facilitate user interpretation and post-processing.

More specifically, according to a first embodiment of the present disclosure, when the metadata is a text type, the corresponding text data is output together with a result of an inference operation performed by the NPU 100. For example, when the NPU 100 performs an operation of detecting and classifying an object from an input video or image, the inference result may be an object name or a class name such as “cat”, “car”, “person”, and the like. Together with this, text metadata such as hardware information of the NPU in which the corresponding operation is performed (e.g., “Model: MobileNet-v2”, “Manufacturer: ABC Inc.”, “Serial Number: NPU123456”) or information on a used neural network model (e.g., “YOLOv5, Version 6.1, Trained on COCO dataset, Training Date: 2023 Aug. 10”) may be output in parallel.

Such an output structure provides various advantages. First, since an origin of an inference result becomes clear, interpretation of the result and securing of reliability become possible. For example, even for the same input image, results may vary when different neural network models or hardware platforms are used, and result comparison and reproduction become easy as metadata is provided together. Second, history management of the inference result or establishment of a verification system becomes possible. An operation history of the entire system may be systematically managed by storing the metadata together in a log system or transmitting the metadata to an analysis server. Third, even in terms of a user interface, text-based metadata becomes a clear information delivery means. For example, when an inference result is displayed on a screen in an AI camera system, if it is output in a form of “person (classified by ResNet50, v2.3, ABC Corp)” instead of simply “person”, a user may intuitively understand from which operation structure the corresponding result is derived. It is also necessary to distinguish whether an output is made by a human or artificial intelligence. Alternatively, it is also necessary to verify the authenticity of the output. This is particularly true for fake videos.

Such metadata output may be formatted inside the NPU 100 to be output as single structured data, and this structured output may be, for example, a simple structure in the form of JSON, XML, or Key-Value. For example, it is as follows:

TABLE 1

```
json
{
  “result”: “ [symbol]   ”,
  “metadata”: {
    “npu_model”: “MobileNet-v2”,
    “npu_serial”: “ABC123456”,
    “nn_model”: “YOLOv5”,
    “version”: “6.1”,
    “training_date”: “2023-08-10”
  }
}
```

By integrally providing the inference result an the meta data in this way, the outside of the system or an interlocked server may receive the result and operation background information at the same time, thereby performing richer post-processing and interpretation.

Meanwhile, according to a second embodiment, when the metadata is an image type, the corresponding image data may be synthesized in advance with an input feature map of the NPU 100 to be input instead of being separately provided as an output result of an inference operation. In other words, it is a method in which a metadata image is combined with input data to be configured as a single input image and then provided to the NPU. This method includes the metadata in a processing flow from an input stage of the NPU, thereby enabling its influence to be reflected throughout the overall operation.

For example, in a situation where a cat picture is given as an input, if a brand logo image of a manufacturer of the NPU is synthesized and input together, this input image may be a form in which the cat picture and the brand logo exist in one frame.

Synthesis may be performed in various ways. The simplest form is a method of inserting a metadata image (e.g., a QR code) into a corner of an input image. As a more advanced method, visual integration between two images may be performed through various image processing technologies including alpha blending, pixel-wise fusion, or region of interest (ROI)-based insertion. In particular, an optimized operation path may be implemented such that this synthesis may be performed in real time in an edge computing environment.

Such an image synthesis-based input method may be understood as another technical means for configuring metadata to be eventually output together with an inference result. For example, after the NPU 100 performs an inference based on the synthesized image, the image data of the QR code included in the input may be returned as a part of the output result together with object information detected from the original image. In this case, the inference result may be provided in the following form:

TABLE 2

```
            json
            {
              “detected_object”: “CAT”,
              “metadata_image”: “qr_code_ABC123456.png”,
              “meta_info”: {
              “manufacturer”: “ABC Corp”,
              “npu_model”: “SqueezeNet-X”
            }
}
```

Such a method may be usefully applied particularly in a vision-based artificial intelligence system. For example, in a factory automation system, an AI system inspecting each component image analyzes a QR code or label image of the corresponding component together with visual characteristics of the component, and includes the analyzed image in an inference result, thereby making it possible to simultaneously perform visual information-based quality inspection and component identification.

Further, according to an embodiment of the present disclosure, an output timing of the metadata may be flexibly set at an operation stage of the NPU or at a system level. For example, in some environments, it may be necessary that the metadata is output in real time together with an inference result, but in other environments, the metadata may be set to be output according to a certain trigger (e.g., when an error occurs or when a specific condition is satisfied). Such dynamic output control may improve the efficiency of system operation and contribute to resource saving by reducing unnecessary data output.

Further, the metadata may also play an important role in securing system security. For example, a digital signature or a hash value for proving that an inference result is generated from a specific authenticated hardware or an authenticated model may also be included as a part of the metadata. In this case, the output metadata may be used to verify whether the result is forged or falsified, and may be particularly usefully applied in high-reliability fields including medicine, finance, defense, and the like.

In summary, the metadata output technology according to the present disclosure provides a means for maximizing a meaning, reliability, traceability, origin distinction, and authenticity information of a result generated in an artificial intelligence system. The text-type metadata enables clear interpretation of the result, and the image-type metadata strengthens a semantic connection between an input and an output through visual integration. Such metadata is stored in a memory internal or external to the NPU, and may be automatically or conditionally output together with an inference result. Further, the metadata is provided in a structured format together with output data, thereby providing an information base that may be easily utilized in a subsequent processing system or a user interface.

As a result, such a technology improves explainability, transparency, and verifiability of an artificial intelligence system, and may play a key role in enhancing the reliability of an AI-based decision-making system in various industrial fields.

Hereinafter, the above-described embodiments will be described in more detail with reference to the drawings.

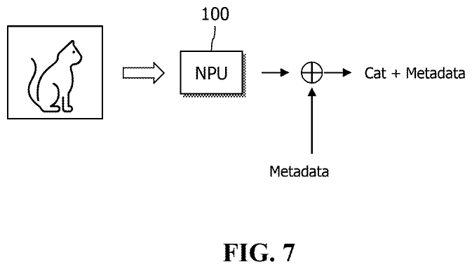

FIG. 7 illustrates an example in which text-type metadata is output together with an inference result of an NPU.

Referring to FIG. 7, an image is input to the NPU 100. The NPU 100 performs classification to output a text “cat”. Meanwhile, the text-type metadata is added to the text “cat” and output.

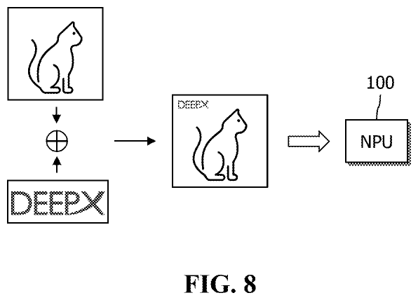

FIG. 8 illustrates an example in which metadata is synthesized with an input image.

Referring to FIG. 8, an image representing hardware identification information, for example, a brand logo image of a manufacturer of the NPU 100, may be synthesized with an image (e.g., a cat image). The synthesized image may be input to the NPU 100.

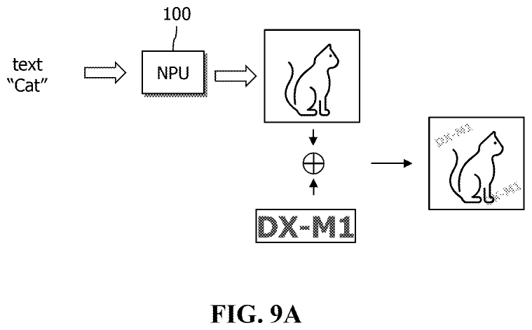

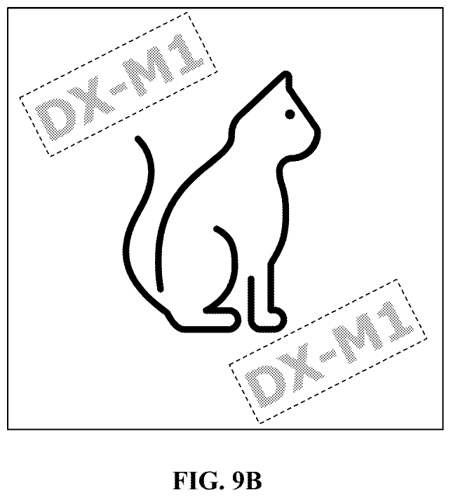

FIG. 9a illustrates an example in which metadata is synthesized with an output (video data), and FIG. 9b illustrates an example of an output image.

Referring to FIG. 9a, when receiving a text “cat” as an input, the NPU 100 may generate a cat image by performing an inference operation using generative AI.

Referring to FIGS. 9a and 9b, the NPU 100 may synthesize (e.g., in a watermark form) an image representing hardware identification information, for example, a model name of the NPU 100, for example, ‘DX-M1’, with the cat image. In such an embodiment, the NPU 100 may add metadata to video data output through an interface.

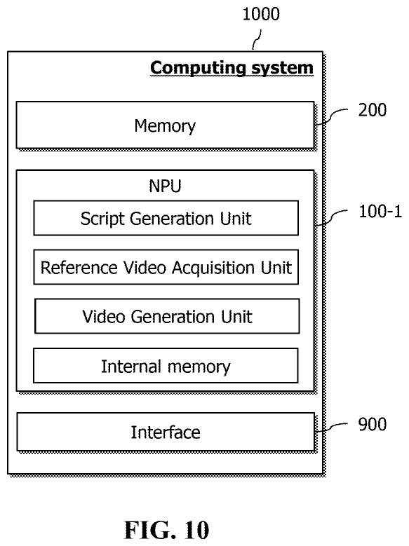

Adding the metadata may include both an embodiment in which the metadata is synthesized with video data to be output inside the NPU 100 and an embodiment in which the NPU 100 separates and outputs the video data and the metadata. Alternatively, the CPU 200 or the MCU 500 may perform the synthesis. FIG. 10 is a block diagram illustrating a computer system according to another example.

Referring to FIG. 10, a computer system 1000 may include an NPU 100-1, a memory 200, and an interface 900. Since the NPU 100-1, the memory 200, and the interface 900 illustrated in FIG. 10 are the same as those illustrated in FIG. 6a or FIG. 6b, descriptions will be made below focusing on operations.

The memory 200 may store a result of compiling an artificial intelligence model based on a generative artificial neural network.

The interface 900 may receive a prompt input by a user.

The NPU 100-1 may generate a technical tutorial video by performing an inference operation on the prompt based on the compilation result.

Specifically, the NPU 100-1 may include a script generator for generating a script suitable for a length of the technical tutorial video desired by the user based on the prompt, a reference video obtainer for obtaining at least one reference video clip based on the prompt, an image generator for obtaining technical tutorial video data by mapping the script and the reference video clip over time, and an internal memory for storing hardware identification information of the NPU. Examples of the hardware identification information are as described above. The reference video clip may be located in a database (DB) located inside or outside the computer system 1000. According to an embodiment, the at least one reference video clip may be received from the outside of the computer system 1000 through the interface 900 of the computer system 1000. The received at least one reference video clip corresponds to the prompt, and for example, if the prompt is ‘make a tutorial video on the topic of the basics of an artificial intelligence semiconductor’, the reference video clip may include a video (including an image) representing artificial intelligence or a video representing a semiconductor. According to an embodiment, a reference video clip related to the prompt may be selected inside the computer system 1000. Alternatively, the reference video clip related to the prompt may be generated inside the NPU 100-1.

The interface 900 may output the technical tutorial video data to the outside by adding the hardware identification information to the technical tutorial video data.

Meanwhile, the system 1000 may further include an image output circuit for generating a final image based on the output data and the hardware identification information.

The image output circuit may insert the hardware identification information into the output data as an overlay such that the hardware identification information is displayed on the final image in a watermark form.

The image output circuit may be a DSP, a GPU, or an ISP.

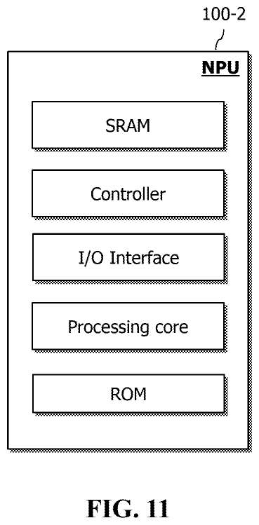

FIG. 11 is a block diagram illustrating an NPU according to an embodiment.

An NPU 100-2 of FIG. 11 may perform the operations of the NPU 100 or the NPU 100-1 described above with reference to FIGS. 1 to 10. Therefore, the operations of the NPU 100 or the NPU 100-1 described above with reference to FIGS. 1 to 10 may also be applied to the NPU 100-2 of FIG. 11.

The NPU 100-2 illustrated in FIG. 11 may include a static random-access memory (SRAM) for loading and storing at least a portion of a compilation result of an artificial intelligence model based on an artificial neural network.

In addition, the NPU 100-2 may include a controller for controlling an operation of the neural processing unit and scheduling an inference operation.

The NPU 100-2 may include an input/output (I/O) interface for receiving input data and transmitting output data generated by performing an inference operation based on the artificial intelligence model.

The NPU 100-2 may include a processing core for generating output data by performing an inference operation using the compilation result. The NPU 100 may include a read-only memory (ROM) for storing hardware identification information of the neural processing unit.

The controller may add the hardware identification information to the output data. The I/O interface may include an output interface for transmitting to the outside.

The hardware identification information may include manufacturer information of the NPU, a model name of the NPU, or a serial number of the NPU.

When the artificial intelligence model is an image generation model such as StyleGAN, VQGAN, or Stable Diffusion, or the output data is image data, the controller may control the hardware identification information to be synthesized with the output data in a watermark form. According to an embodiment, image data generated as an inference result of an artificial intelligence model may be updated to include hardware identification information. For example, at least some of pixel values of an output image generated in a processing core may be changed by adding the hardware identification information.

### Summary of Examples

According to an aspect of the present disclosure, a system is provided. The system may include an interface for obtaining input data from a user, one or more external memories for storing a result of compiling an artificial intelligence model based on an artificial neural network, and a neural processing unit (NPU) generating output data by performing an inference operation on the input data using the compilation result. The NPU may include a controller for controlling an operation of the NPU and scheduling the inference operation, a processing core for performing the inference operation, and at least one internal memory for storing parameters of the artificial neural network required for the inference operation. Metadata enabling recognition of an origin of the output data may be added to the output data. The metadata may include hardware identification information of the NPU or information on the artificial intelligence model. The metadata may be stored in the internal memory.

The internal memory may include a read-only nonvolatile memory for storing the hardware identification information.

The hardware identification information may include manufacturer information of the NPU, a model name of the NPU, or a serial number of the NPU.

The read-only nonvolatile memory may include a mask ROM (Read Only Memory), an OTP (One time password) ROM, a PROM (Programmable Read-Only Memory), or an eFuse (Electronic Fuse).

When manufacturing the NPU, the hardware identification information may be recorded in the read-only nonvolatile memory.

When it is determined that the output data is image data, the controller may read the hardware identification information from the internal memory and add the hardware identification information to the image data such that the hardware identification information is displayed on the image data in a watermark form when the image data is generated.

If the artificial intelligence model is StyleGAN (Style-based Generative Adversarial Network), VQGAN (Vector Quantized Generative Adversarial Network), or Stable Diffusion, the output data may be determined as image data.

The hardware identification information may be in a form of a barcode or QR code image.

The information on the artificial intelligence model may include one or more of information on a model family, a model name, a model version, a training version, a training date, a framework, and a used learning dataset.

When the input data is a prompt input by the user and the output data is image data generated based on the prompt, the controller may add the metadata to the image data such that the hardware identification information or the information on the artificial intelligence model is displayed on a final image shown to the user in a watermark form.

When the input data is a prompt input by the user and the output data is image data generated based on the prompt, the controller may input the input data to the artificial intelligence model to obtain a script of a predetermined length and at least one reference video clip, obtain technical tutorial video data that is the output data by mapping the script and the reference video clip, and then add the metadata to the technical tutorial video data such that the metadata is displayed on a final technical tutorial video shown to the user in a watermark form.

According to an aspect of the present disclosure, a system is provided. The system may include an interface for receiving a prompt input by a user, one or more external memories for storing a result of compiling an artificial intelligence model based on a generative artificial neural network, and a neural processing unit (NPU) generating a technical tutorial video by performing an inference operation on the prompt based on the compilation result.

The NPU may include a script generator for generating a script suitable for a length of the technical tutorial video desired by the user based on the prompt, a reference video obtainer for obtaining at least one reference video clip based on the prompt, an image generator for obtaining technical tutorial video data by mapping the script and the reference video clip over time, and an internal memory for storing hardware identification information of the NPU. The interface may output the technical tutorial video data to the outside by adding the hardware identification information to the technical tutorial video data.

The system may further include an image output circuit for generating a final image based on the output data and the hardware identification information. The image output circuit may insert the hardware identification information into the output data as an overlay such that the hardware identification information is displayed on the final image in a watermark form.

The image output circuit may include a DSP, a GPU, or an ISP.

According to an aspect of the present disclosure, a neural processing unit is provided. The neural processing unit may include a static random-access memory (SRAM) for loading and storing at least a portion of a compilation result of an artificial intelligence model based on an artificial neural network, a controller for controlling an operation of the neural processing unit and scheduling an inference operation, an input/output (I/O) interface for receiving input data, a processing core for generating output data by performing the inference operation using the compilation result, and a read-only memory (ROM) for storing hardware identification information of the neural processing unit, and the controller may add the hardware identification information to the output data and the I/O interface may include an output interface for transmitting to the outside. The hardware identification information may include manufacturer information of the NPU, a model name of the NPU, or a serial number of the NPU.

When the artificial intelligence model is StyleGAN, VQGAN, or Stable Diffusion, or the output data is image data, the controller may add the hardware identification information to the output data such that the hardware identification information is displayed on the output data in a watermark form.

Although examples of the present disclosure have been described in more detail with reference to the accompanying drawings, the present disclosure is not necessarily limited to these examples, and various modifications may be implemented without departing from the technical spirit of the present disclosure. Therefore, the examples disclosed in the present disclosure are not intended to limit the technical spirit of the present disclosure but to explain, and the scope of the technical spirit of the present disclosure is not limited by these examples. Therefore, it should be understood that the examples described above are illustrative in all respects and not restrictive. The protection scope of the present disclosure should be interpreted by the following claims, and all technical spirits within the equivalent scope should be interpreted as being included in the scope of rights of the present disclosure.

[National R&D Project Supporting this Invention]
[Project Unique Number]2710007843
[Project Number]00228938
[Ministry] Ministry of Science and ICT
[Project Management (Specialized) Agency] Institute of Information & Communications Technology Planning & Evaluation (IITP)
[R&D Program Name] Development of an AI Semiconductor SW Integrated Platform Technology
[Project Title] Development of a Commercial Edge AI SoC Semiconductor SW Platform Technology
[Performing Organization] DeepX Co., Ltd.
[Research Period]2024.01.01~2024.12.31

What is claimed is:

1. A computer system, comprising:
an interface configured to obtain input data from a user;
one or more external memories configured to store a result of compiling an artificial intelligence model based on an artificial neural network; and
a neural processing unit (NPU) configured to generate output data by performing an inference operation on the input data using the result of compiling,
wherein the NPU comprises:
a controller configured to control an operation of the NPU and schedule the inference operation;
a processing core configured to perform the inference operation; and
at least one internal memory configured to store a parameter of the artificial neural network required for the inference operation,
wherein metadata is configured to enable recognition of an origin of the output data is added to the output data,
wherein the metadata includes hardware identification information of the NPU or information on the artificial intelligence model, and
wherein the metadata is stored in the at least one internal memory.

2. The computer system of claim 1,
wherein the at least one internal memory comprises a read-only nonvolatile memory configured to store the hardware identification information, and
wherein the hardware identification information includes manufacturer information of the NPU, a model name of the NPU, or a serial number of the NPU.

3. The computer system of claim 2,
wherein the read-only nonvolatile memory comprises a mask read only memory (ROM), an one-time password (OTP) ROM, a programmable read-only memory (PROM), or an electronic fuse (eFuse), and
wherein the hardware identification information is recorded in the read-only nonvolatile memory during manufacturing of the NPU.

4. The computer system of claim 1,
wherein, when it is determined that the output data is image data, the controller reads the hardware identification information from the at least one internal memory and adds the hardware identification information to the image data such that the hardware identification information is displayed on the image data in a watermark form when the image data is generated.

5. The computer system of claim 4,
wherein, when the artificial intelligence model is a style-based generative adversarial network (StyleGAN), a vector quantized generative adversarial network (VQGAN), or Stable Diffusion, the output data is determined as the image data.

6. The computer system of claim 1,
wherein the hardware identification information is in a form of a barcode or QR code image.

7. The computer system of claim 1,
wherein the information on the artificial intelligence model includes information on a model family, a model name, a model version, a training version, a training date, a framework, or a used learning dataset.

8. The computer system of claim 1,
wherein the input data is a prompt input by the user,
wherein the output data is image data generated based on the prompt input, and
wherein the controller adds the metadata to the image data such that the hardware identification information or the information on the artificial intelligence model is displayed on a final image shown to the user in a watermark form.

9. The computer system of claim 1,
wherein the input data is a prompt input by the user,
wherein the output data is image data generated based on the prompt input, and
wherein the controller obtains a script of a predetermined length and at least one reference video clip by inputting the input data to the artificial intelligence model, obtains technical tutorial video data that is the output data by mapping the script and the at least one reference video clip, and adds the metadata to the technical tutorial video data such that the metadata is displayed on a final technical tutorial video shown to the user in a watermark form.

10. A computer system, comprising:
an interface to receive a prompt input by a user;
one or more external memories to store a result of compiling an artificial intelligence model based on a generative artificial neural network; and
a neural processing unit (NPU) to generate a technical tutorial video by performing an inference operation on the prompt input based on the result of compiling,
wherein the NPU comprises:
a script generator to generate a script suitable for a length of the technical tutorial video desired by the user based on the prompt input;
a reference video obtainer to obtain at least one reference video clip based on the prompt input;
an image generator to obtain technical tutorial video data by mapping the script and the at least one reference video clip over time; and
an internal memory to store hardware identification information of the NPU, and
wherein the interface outputs the technical tutorial video data to an outside by adding the hardware identification information to the technical tutorial video data.

11. The computer system of claim 10,
further comprising an image output circuit to generate a final image based on the technical tutorial video data and the hardware identification information,
wherein the image output circuit inserts the hardware identification information into the technical tutorial video data as an overlay such that the hardware identification information is displayed on the final image in a watermark form, and
wherein the image output circuit comprises a digital signal processor (DSP), a graphic processing unit (GPU), or an image signal processor (ISP).

12. A neural processing unit (NPU), comprising:
an SRAM to load and store at least a portion of a compilation result of an artificial intelligence model based on an artificial neural network;
a controller to control an operation of the NPU and schedule an inference operation;
an input/output (I/O) interface to receive input data;
a processing core to generate output data by performing the inference operation using the compilation result; and
a ROM to store hardware identification information of the NPU,
wherein the controller adds the hardware identification information to the output data, and the I/O interface comprises an output interface for transmitting to an outside, and
wherein the hardware identification information includes manufacturer information of the NPU, a model name of the NPU, or a serial number of the NPU.

13. The neural processing unit of claim 12,
wherein, when the artificial intelligence model is a StyleGAN, a VQGAN, or Stable Diffusion, or the output data is image data, the controller adds the hardware identification information to the output data such that the hardware identification information is displayed on the output data in a watermark form.
